(19) United States
(12) Patent Application Publication
(10) Pub. No.: US 2024/0152934 A1
(43) Pub. Date: May 9, 2024

(54) CONTACT VERIFICATION AND NON-REPUDIATION SYSTEM

(71) Applicant: INCONTACT INC., Sandy, UT (US)

(72) Inventors: Tom OTVOS, Mississauga (CA); Don REITH, Ventura, CA (US)

(21) Appl. No.: 18/053,634

(22) Filed: Nov. 8, 2022

(51) Int. Cl. G06Q 30/00

(52) U.S. Cl. CPC G06Q 30/018

(57) ABSTRACT

A system automatically validates stored information related to a contact session. The system includes a processor configured with instructions to: receive a recording or transcript of a contact session; receive or generate metadata related to the recording or transcript; store the recording, transcript, and metadata in a memory; compute a hash of at least the recording, transcript, or metadata; and store the hash in a blockchain. The hash is indexed within the blockchain by at least a portion of the metadata. The processor is also configured to: retrieve the hash from the blockchain; retrieve the hash from memory or re-compute the hash; compare the retrieved hash to the re-computed hash or the hash retrieved from memory. If the retrieved hash matches the re-computed hash or the hash retrieved from memory, the system will generate a first output, and if not, the system will generate a second output.

### TECHNICAL FIELD

The subject matter described herein relates to systems, methods, and devices for providing a clear audit trail for customer contacts, e.g., to demonstrate that a particular contact took place. This contact verification system has particular but not exclusive utility in contact centers and other customer-facing support centers.

### BACKGROUND

A contact center allows an organization (such as a bank, government office, or other service provider) to receive contacts from their patrons, or to initiate contacts with their patrons as a part of their business operations. These contacts may be through various channels, such as (but not limited to) phone calls, emails, chats, or social media messages. Contact center activity may occur across multiple, disparate systems, including inbound and manually dialed outbound calls via an automated call distributor (ACD), automated outbound contacts via a dialer, automated interactions patrons have with “bots”, digital contacts via chat, SMS, or other messaging systems. The audit trails for these various contacts may be distributed across each of these systems, each with their own metadata. This distribution of data amplifies the risks of tampering, accidental loss, and purging.

In certain cases, depending on the service being provided by an organization or due to compliance regulations that the organization is bound by, there must be a very clear record, or audit trail, of a contact that was made by the organization's patrons to the organization, or conversely by the organization to a specific patron. While many contact centers will maintain some form of database to log such contacts, this type of audit trail has limitations in that such logging generally does not have any protection against tampering. Additionally, log data can be accidentally lost, or deliberately purged over a period of time.

Repudiation of a contact may for example occur when at least one alleged participant of the contact later claims that the contact did not occur, or that stored data associated with the contact is incorrect.

There are numerous contact center use cases where non-repudiation of a contact (did the contact occur, and when) is vital to business operations. Examples include trading desks, prisoner call tracking, parole and probation check-in, call-based billing, and public safety call records. In such cases, database rows, call recordings, and log files may provide the only record that the contact took place. Unfortunately, such records can be lost or tampered with in some way. Additionally, there may be compliance cases where a stronger audit trail is required (e.g., monitoring the playback of sensitive recordings) and where simple log files are insufficient to prove access.

A second use case that has been explored is the auditing of “evidence transformation”: immutably recording the steps taken to transform evidence gathered in criminal investigations from one form to another. Repudiation of a piece of digital evidence may for example occur when the validity of a processing step (e.g., transformation from one format to another) is called into question.

Thus, a need exists for systems, methods, and devices to provide improved audit trails.

### SUMMARY

A contact verification system is disclosed, which provides an audit trail that can confirm the occurrence of a contact. Call metadata (including a hash of the contact recording or transcript) is packaged into a “non-repudiation record”. A one-way encryption or “hash” of the record is posted to a private or public blockchain, which serves as a “trusted third party” where non-repudiation is required for compliance or other reasons. The one-way encryption of the hash function ensures that the sensitive data included in the hash is non-discoverable, while the blockchain ledger provides an immutable record of the contact. The index for each non-repudiation record on the blockchain may be stored in a local database, to facilitate retrieval. A validation tool (e.g., one that recomputes the hash and compares it to what was stored on the blockchain) allows a contact to be matched with the respective blockchain record of the contact, to confirm the record has not been altered. This provides a positive indication that a locally held record of the contact is true. An equivalent verification system can also be used to verify chain of custody for digital evidence, e.g., when a digital file is converted from one format to another.

A system of one or more computers can be configured to perform particular operations or actions by virtue of having software, firmware, hardware, or a combination thereof installed on the system that in operation cause(s) the system to perform the actions. One or more computer programs can be configured to perform particular operations or actions by virtue of including instructions that, when executed by data processing apparatus, cause the apparatus to perform the actions. One general aspect includes a system adapted to automatically validate stored information related to a contact session. The system includes a processor and a non-transitory computer readable medium operably coupled thereto, the computer readable medium including a plurality of instructions stored in association therewith that are accessible to, and executable by, the processor, to perform operations which include: receiving a recording or transcript of a contact session; receiving or generating metadata related to the recording or transcript; storing the recording, transcript, and metadata in a memory; with a hash function, computing a hash of at least one of the recording, transcript, or metadata; storing the hash in a blockchain different from the memory, where the hash is indexed within the blockchain by at least a portion of the metadata; using the at least a portion of the metadata, retrieving the hash from the blockchain; retrieving the hash from the memory or, with the hash function, re-computing the hash of the recording, transcript, or metadata; comparing the retrieved hash to the re-computed hash or the hash retrieved from the memory; if the retrieved hash matches the re-computed hash or the hash retrieved from the memory, generating a first output; and if the retrieved hash does not match the re-computed hash or the hash retrieved from the memory, generating a second output. Other aspects of this aspect include corresponding computer systems, apparatus, and computer programs recorded on one or more computer storage devices, each configured to perform the actions of the methods.

Implementations may include one or more of the following features. In some aspects, the recording includes at least one of a voice recording of the contact session or a recording of computer screen activity of the contact session. In some aspects, the transcript includes a recording of at least one of a text interaction, a text translation of a voice interaction, or a text translation of computer screen activity. In some aspects, the hash function includes a one-way hash function. In some aspects, the metadata includes at least one of a date, a time, a unique contact identifier, a phone number, a contact center agent identifier, an email address, a social media identifier, or a contact duration. In some aspects, the first output includes an indication that the recording or transcript is validated, and the second output includes an indication that the recording or transcript is not validated. In some aspects, the blockchain is a public blockchain, a smart contract includes at least some of the operations, and the operations further include: paying a usage fee for the public blockchain; and charging a customer (also referred to herein as a “patron”) for the usage fee. In some aspects, the blockchain is a private blockchain, a smart contract includes at least some of the operations, and the operations further include charging a customer a usage fee for the private blockchain. Implementations of the described techniques may include hardware, a method or process, or computer software on a computer-accessible medium.

One general aspect includes a computer-implemented method adapted to automatically validate stored information related to a contact session. The computer-implemented method includes receiving a recording or transcript of a contact session; receiving or generating metadata related to the recording or transcript; storing the recording, transcript, and metadata in a memory; with a hash function, computing a hash of at least one of the recording or transcript, or metadata; storing the hash in a blockchain different from the memory, where the hash is indexed within the blockchain by at least a portion of the metadata; using the at least a portion of the metadata, retrieving the hash from the blockchain; retrieving the hash from the memory or, with the hash function, re-computing the hash of the recording or transcript; comparing the retrieved hash to the re-computed hash or the hash retrieved from the memory; if the retrieved hash matches the re-computed hash or the hash retrieved from the memory, generating a first output; and if the retrieved hash does not match the re-computed hash or the hash retrieved from the memory, generating a second output. Other aspects of this aspect include corresponding computer systems, apparatus, and computer programs recorded on one or more computer storage devices, each configured to perform the actions of the methods.

Implementations may include one or more of the following features. In some aspects, the recording includes at least one of a voice recording of the contact session or a recording of screen activity of the contact session. In some aspects, the transcript includes a recording of at least one of a text interaction, a text translation of a voice interaction, or a text translation of computer screen activity. In some aspects, the hash function includes a one-way hash function. In some aspects, the metadata includes at least one of a date, a time, a unique contact identifier, a phone number, a contact center agent identifier, an email address, a social media identifier, or a contact duration. In some aspects, the first output includes an indication that the recording or transcript is validated, and the second output includes an indication that the recording or transcript is not validated. In some aspects, the blockchain is a public blockchain, a smart contract includes at least a portion of the method, and the method further includes: paying a usage fee for the public blockchain; and charging a customer for the usage fee. In some aspects, the blockchain is a private blockchain, a smart contract includes at least a portion of the method, and the method further includes: charging a customer a usage fee for the private blockchain. Implementations of the described techniques may include hardware, a method or process, or computer software on a computer-accessible medium.

One general aspect includes a computer-implemented method adapted to automatically validate a chain of custody related to a piece of electronic evidence. The computer-implemented method includes receiving the piece of electronic evidence; receiving or generating metadata related to the piece of electronic evidence; performing steps to transform the piece of electronic evidence into a transformed piece of electronic evidence; storing the piece of electronic evidence, the steps, the transformed piece of electronic evidence, and the metadata in a memory; with a hash function, computing a hash of at least the piece of evidence, the steps, and the transformed piece of electronic evidence; storing the hash in a blockchain different from the memory, where the hash is indexed within the blockchain by at least a portion of the metadata; using the at least a portion of the metadata, retrieving the hash from the blockchain; retrieving the hash from the memory or, with the hash function, re-computing the hash of at least the piece of evidence, the steps, and the transformed piece of electronic evidence; comparing the retrieved hash to the re-computed hash or the hash retrieved from the memory; if the retrieved hash matches the re-computed hash or the hash retrieved from the memory, generating a first output; and if the retrieved hash does not match the re-computed hash or the hash retrieved from the memory, generating a second output. Other aspects of this aspect include corresponding computer systems, apparatus, and computer programs recorded on one or more computer storage devices, each configured to perform the actions of the methods.

One general aspect includes a computer-implemented method adapted to automatically validate an electronic data structure. The computer-implemented method includes receiving the electronic data structure; receiving or generating data related to the electronic data structure; storing the electronic data structure or the generated data in a memory; with a hash function, computing a hash of at least the electronic data structure or the data; storing the hash in a blockchain different from the memory, where the hash is indexed within the blockchain by at least a portion of the data; using the at least a portion of the data, retrieving the hash from the blockchain; retrieving the hash from the memory or, with the hash function, re-computing the hash of at least the electronic data structure or the data; comparing the retrieved hash to the re-computed hash or the hash retrieved from the memory; if the retrieved hash matches the re-computed hash or the hash retrieved from the memory, generating a first output; and if the retrieved hash does not match the re-computed hash or the hash retrieved from the memory, generating a second output. Other aspects of this aspect include corresponding computer systems, apparatus, and computer programs recorded on one or more computer storage devices, each configured to perform the actions of the methods.

Implementations may include one or more of the following features. In some aspects, the electronic data structure includes a recording or transcript of a customer interaction or a piece of electronic evidence. In some aspects, the data includes metadata or processing steps. Implementations of the described techniques may include hardware, a method or process, or computer software on a computer-accessible medium.

This Summary is provided to introduce a selection of concepts in a simplified form that are further described below in the Detailed Description. This Summary is not intended solely to identify key features or essential features of the claimed subject matter, nor is it intended to limit the scope of the claimed subject matter. A more extensive presentation of features, details, utilities, and advantages of the contact verification system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a representation, in block diagram form, of at least a portion of an example contact center, according to aspects of the present disclosure.

FIG. 2 is a representation, in block diagram form, of at least a portion of an example generic blockchain architecture or blockchain ecosystem, according to aspects of the present disclosure.

FIG. 3 is a representation, in flow diagram form, of at least a portion of an example contact hashing and storage method, according to aspects of the present disclosure.

FIG. 4 is a representation, in flow diagram form, of at least a portion of an example contact verification method, according to aspects of the present disclosure.

FIG. 5 is a representation, in block diagram form, of at least a portion of an example contact hashing and storage method, according to aspects of the present disclosure.

FIG. 6 is a representation, in block diagram form, of at least a portion of an example contact verification method, according to aspects of the present disclosure.

FIG. 7 is a representation, in flow diagram form, of at least a portion of an example chain of evidence validation method, according to aspects of the present disclosure.

FIG. 8 is a schematic diagram of a processor circuit, according to aspects of the present disclosure.

### DETAILED DESCRIPTION

A long-felt need exists for systems, methods, and devices to store and validate contact records or chains of evidence in a manner that minimizes the risk of, or prevents, later repudiation. The present disclosure provides a contact verification system or repudiation rejection system, which can utilize a blockchain (whether public or private) as a trusted third party for verification. The contact verification system may for example be helpful in reducing the risk or severity of, or avoiding, repudiation of a contact center contact by a customer, or repudiation of reformatted digital evidence in adversarial proceedings.

It is noted that a contact center management system (such as NICE CXone) allows an organization (such as a bank, government office, or other service provider) to receive contacts from their customers, or to initiate contacts with their customers as a part of their business operations. These contacts may be through various channels, including phone calls, emails, chats, or social media messages, and may include contact metadata (date/time, parties involved, . . . ) and/or contact media (audio recording, digital transcript). The contact verification system digitally hashes and signs some or all of this information. This payload is then uploaded to a public or private (invitation-only) blockchain. Once on the blockchain, the payload cannot be tampered with, and is visible to all users that have access to the blockchain. A reference to this immutable record is then stored with the contact records.

Currently, non-repudiation is typically addressed through a combination of log files and database records, and so is principally based on trust that neither has been modified. Companies will go through audits and certifications to earn that trust but, fundamentally, mistakes can be made and accidents can occur. Additionally, “bad actors” within a company can often effect impactful changes (whether small or large) to logs and databases while remaining undetected.

The contact verification system provides an immutable audit trail that can confirm the occurrence of a contact. Call metadata (which may include a hash of the contact recording or transcript) is packaged into a “non-repudiation record.” Details of what gets stored may be customer-defined, including use of the recording or transcript. A one-way encryption or “hash” of the record is posted to a private or public blockchain. Where non-repudiation is required for compliance or other reasons, the blockchain can thus replace human or other escrow services, such as human oversight or eyewitness testimony, that would otherwise be required to establish trust.

The blockchain may be private (e.g., operated by a service provider on an invitation-only basis, as with AWS Managed Blockchain, IBM Blockchain, Oracle Blockchain, etc.) or public (e.g., Ethereum, Solana, Hyperledger Fabric, Stellar, Corda, etc.). A private blockchain may for example be appropriate where it is not desired that the data used to index the non-repudiation record be publicly visible. In either case, the one-way encryption of the hash function helps ensure that the sensitive data included in the hash is non-discoverable, while the blockchain ledger provides an immutable record of the contact. The index for each non-repudiation record on the blockchain may for example be stored in a local database, to facilitate later retrieval of the hash from the blockchain.

By storing contact metadata, and a one-time hash of that metadata, on a private or public blockchain, and possibly also including a one-time hash of the contact transcript or voice recording, an immutable record of the contact is stored and visible to all participants of the blockchain. Validation can be provided that recomputes the hash and compares it to what was stored on the blockchain. The contact verification system can provide this immutable record of contact for each contact system, or media type, employed by the contact center. Storing the hash and/or digital signature of the contact data, as opposed to only the contact data itself, allows a trusted public ledger to be updated without leaking customer or other information to unauthorized third parties.

In some embodiments, a validation tool allows a contact to be matched with the respective blockchain record of the contact, to confirm the recording, transcript, or metadata associated with the contact has not been altered. This provides a positive indication that a locally held record of the contact is true, complete, and accurate. Depending on the blockchain being utilized, this record may be permanent.

When validation is required, the contact can then be inspected, a new hash computed using the same contact data, and the resulting hash can be compared to what is stored on the blockchain. If the hashes match, then the contact record and all of the details in the hash can be relied on as true, complete, and accurate.

In some embodiments, operations such as the computation of the one-way hash and the validation of data may be performed on the blockchain through the use of “smart contracts” on the blockchain. Since these contracts are also immutable, this augments the trust in system to record, and validate, data stored on the blockchain ledger.

At the time of capture, a copy of the contact information can be written to write-once-read-only (“WORM”) media devices. However, WORM devices are subject to mechanical failure and technical obsolescence. WORM storage solutions not based on special purpose mechanical devices can protect files from alteration but still allow a “trusted administrator” to delete files or complete volumes.

Video or screen recordings of the original activity can be made. However, these solutions are also at risk to subsequent modification. Additionally, this type of solution can incur a significant storage cost when bulk data must be stored or data must be stored for a longer period of time. Such options also are not a solution for programmatic detection of change.

It is noted that blockchain is typically not used in the contact center space. Indeed, in the current technological environment, “blockchain” is usually synonymous with “cryptocurrency,” because blockchain technology is still relatively new, and most applications are in the “currency” and “non-fungible token” space—use cases that depend on establishing trust and verification. While the immutable aspect of blockchain ledgers lends itself to providing trust in other application areas, it is not an obvious leap to link blockchains with contact centers. Implementation details in particular require novel devices, methods, and/or systems. It is also novel to utilize smart contracts for both the immutable audit of a contact center contact event, and the subsequent validation of that event, to ensure the validation is done consistently. This contact verification system can form the foundation of enhanced contact center systems for customers that have legal or compliance requirements, such as customers in public safety, financial, insurance, or other industries that have contract adherence concerns. One option is to create one or more private blockchains for this purpose, although public blockchains may be used instead or in addition where the underlying contact data is preferably encrypted. Storing hash and/or digital signature of contact data, as opposed to contact data itself, allows a public ledger to be updated without leaking customer information.

Related art includes LogSentinel, which provides a generic audit trail of service log data through a blockchain, but is not specific to contact centers or the unique aspects of a Contact Center as a Service (CCasS) application (e.g., contact metadata plus recording). In particular, LogSentinel does not address the non-repudiation of a contact center contact, by storing and retrieving a hash of the contact records as disclosed herein.

Mea Fuse provides a blockchain-based digital evidence ledger for law enforcement, forensics, and legal providers. However, Mea Fuse does not have features to allow users to verify (and if necessary, repeat) the transformation steps that are used to transform digital evidence. Such transformation may for example include converting a digital file from one format to another, but may also include more detailed actions such as image enhancement, audio enhancement, cropping, zooming, resizing, compression/decompression, noise filtering, font substitution, language translation, subtitling, and otherwise.

The systems and methods described in this disclosure are specifically targeting the concept of “non-repudiation,” or guaranteeing unequivocally that something happened, or did not happen, at a specific point in time and in a specific way. Additionally, while non-repudiation has very broad applicability, the present disclosure focuses on how non-repudiation can be enhanced in a contact center environment through the use of “blockchain” technology.

The contact verification system could also be used by applications and services that specialize in the collection of activity or audit log data, and may be used directly by the customers who may be collecting and consolidating audit trail data across the disparate systems currently in use.

The contact verification system can also be used to verify chain of custody for digital evidence, e.g., when a digital file is converted from one format to another. Typically, this type of transformation is common when digital data is captured in one proprietary format, and needs to be transformed into another format that is more readily consumable. Since a transformation of evidence can introduce (artificially or deliberately) changes that can materially affect criminal proceedings, a clear and immutable record of the series of steps and the tools utilized must be recorded to allow the transformation to be repeated and verified.

The present disclosure aids substantially in limiting or avoiding the ability to credibly repudiate a contact or a piece of digital evidence, by providing a visible, immutable, verifiable audit trail. Implemented on a processor in communication with a memory structure or database, the system disclosed herein provides practical “trusted third party” verification, without increased risk of the exposure of sensitive data. This improved audit trail transforms an insecure, alterable record that depends on physical storage media into a fast, accurate, repeatable, and resource-efficient validation process that can be executed against live or stored contacts on demand, without the normally routine need for human oversight or testimony, or escrow services. This unconventional approach improves the functioning of the computer systems of the service provider (e.g., a call center or other contact center), by providing immutable evidence that a particular event occurred, without increasing the volume of exposed data.

The contact verification system may be implemented as a process at least partially viewable on a display, and operated by a control process executing on a processor that accepts user inputs from a keyboard, mouse, or touchscreen interface, and that is in communication with one or more databases. In that regard, the control process performs certain specific operations in response to different inputs or selections made at different times. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the contact verification system and methods set forth herein. Certain features may be added, removed, or modified without departing from the spirit of the claimed subject matter.

Glossary—the following terms, are used in this disclosure.

ACD: Automated Call Distributor, a telephony device or service that answers and distributes incoming calls to a specific group of applications, terminals, or agents within an organization.

Bot: a computer program that converses with a patron, via text or voice, in natural language.

Blockchain: a distributed database or ledger of data, cryptographically linked to prevent alteration of data once it has been validated on the ledger.

One-way Hash: a repeatable, cryptographically secure algorithm that transforms a series of digital data bytes into a single, large number, for which it is practically infeasible to invert or reverse the computation, and that is also infeasible to have two series of bytes generate the same value.

Smart Contract: a (relatively) small and immutable software program that can be executed on a specific blockchain infrastructure to perform a well-defined and well-known function or service.

JSON: JavaScript Object Notation, a standard, text-based format for describing data structures, commonly used to send structured data between applications.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one of ordinary skill in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

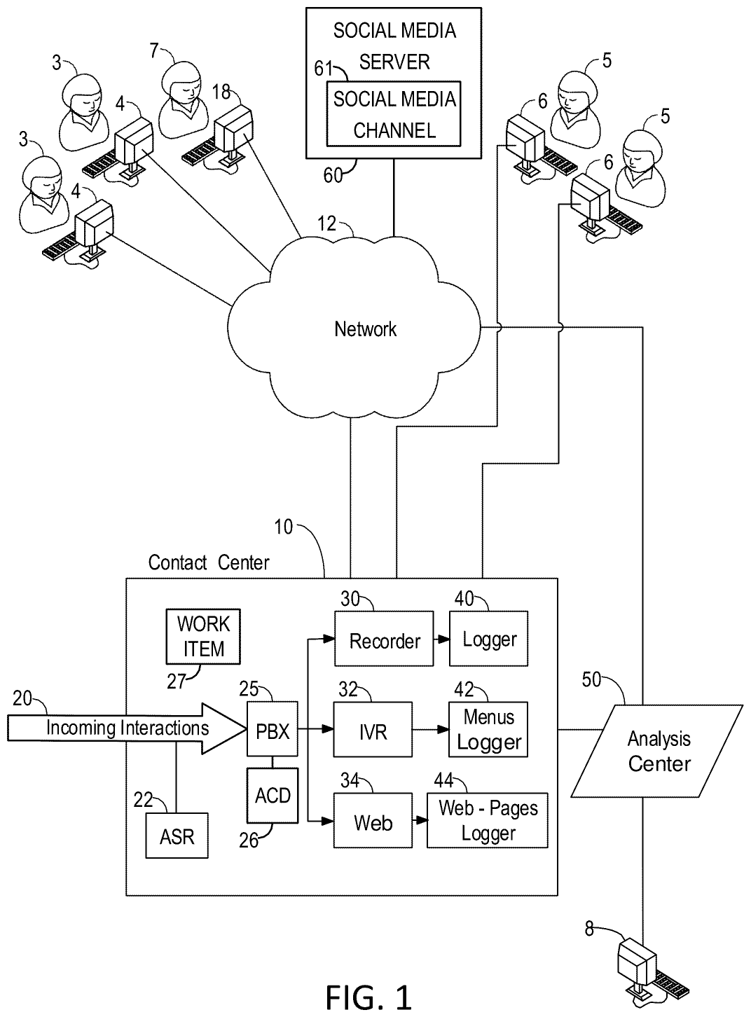

FIG. 1 is a representation, in block diagram form, of at least a portion of an example contact center 10, according to aspects of the present disclosure. The term “contact center,” as used herein, can include any facility or system server suitable for receiving and recording electronic communications from contacts, or for assisting a contact center to analyze and implement any of the steps or embodiments disclosed herein. Such contact communications can include, for example, telephone calls, facsimile transmissions, e-mails, web interactions, voice over IP (“VoIP”) and video. Various specific types of communications contemplated through one or more of these channels include, without limitation, email, SMS data (e.g., text), tweet, instant message, web-form submission, smartphone app, social media data, and web content data (including but not limited to internet survey data, blog data, microblog data, discussion forum data, and chat data), etc. In some embodiments, the communications can include contact tasks, such as taking an order, making a sale, responding to a complaint, etc. In various aspects, real-time communication, such as voice, video, or both, is preferably included. It is contemplated that these communications may be transmitted by and through any type of telecommunication device and over any medium suitable for carrying data. For example, the communications may be transmitted by or through telephone lines, cable, or wireless communications. As shown in FIG. 1, the contact center 10 of the present disclosure is adapted to receive and record varying electronic communications and data formats that represent an interaction that may occur between a contact (or caller) and a contact center agent during fulfillment of a contact and agent transaction. In one embodiment, the contact center 10 records all of the contact calls in uncompressed audio formats.

In the illustrated embodiment, contacts may communicate with agents associated with the contact center 10 via multiple different communication networks 12 such as a public switched telephone network (PSTN) or the Internet. For example, a contact may initiate an interaction session through traditional telephones, a fax machine, a cellular (i.e., mobile) telephone, a personal computing device with a modem, or other legacy communication device via the PSTN. Further, the contact center 10 may accept internet-based interaction sessions from patrons 3, 5, 7 via personal computing devices 6, VoIP telephones 18, and internet-enabled smartphones and personal digital assistants (PDAs) 4. Note that in the illustrated embodiment, patron interactions 20 are shown as incoming to contact center 10, but in other embodiments, interactions can be equally represented as being initiated by the contact center and outgoing from the contact center to the patron.

An interaction 20 may be, may generate, or may alter a work item 27. The incoming interactions 20 are received by a private branch exchange 25 and/or solicited by an automated call distributor 26, either or both of which may generate an interactive voice response (IVR) 32 that is received by a menus logger 42 that records the customer's responses. The incoming interactions, or portions thereof, may in some cases be processed by an automated speech recognition system (ASR) 22. The ASR 22 may for example provide a capability for the IVR 32 to allow spoken words or phrases to be interpreted as actions. In an example, the ASR 22 may allow a patron to utter “Sales” to speak to a salesperson instead of pressing 2 on the keypad.

In certain cases, depending on the service being provided by the organization or due to compliance regulations that the organization is bound by, there must be a very clear record, or audit trail, of a contact that was made by the organization's patrons to the organization, or conversely by the organization to a specific patron. Contact centers will typically record voice or digital patron interactions 30, and will maintain some form of database 40 to log such contacts. Similarly, an interactive voice response system (IVR) 32 may provide an audit trail via a menu logger 42, and a web server or web browser 34 may provide an audit trail via a web logger 44. Audit trails in the loggers 40, 42, and 44 may be accessible through an analysis center 50 via a remote terminal 8.

However, these types of audit trails have limitations in that such logging generally does not have any protection against tampering. Additionally, log data can be accidentally lost, or deliberately purged over a period of time, thus providing potential basis for repudiation of a specific contact (or the content of a contact) by a specific patron or related third party such as an agent of the patron (e.g., spouse, heir, attorney, CPA, etc.). To address this vulnerability, the contact verification system of the present disclosure enhances the audit trail of contacts by storing contact data on a private or public blockchain, where it is immutably and permanently stored, and available for inspection by all participants of the blockchain.

It is noted that block diagrams are provided herein for exemplary purposes; a person of ordinary skill in the art will recognize myriad variations that nonetheless fall within the scope of the present disclosure. For example, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

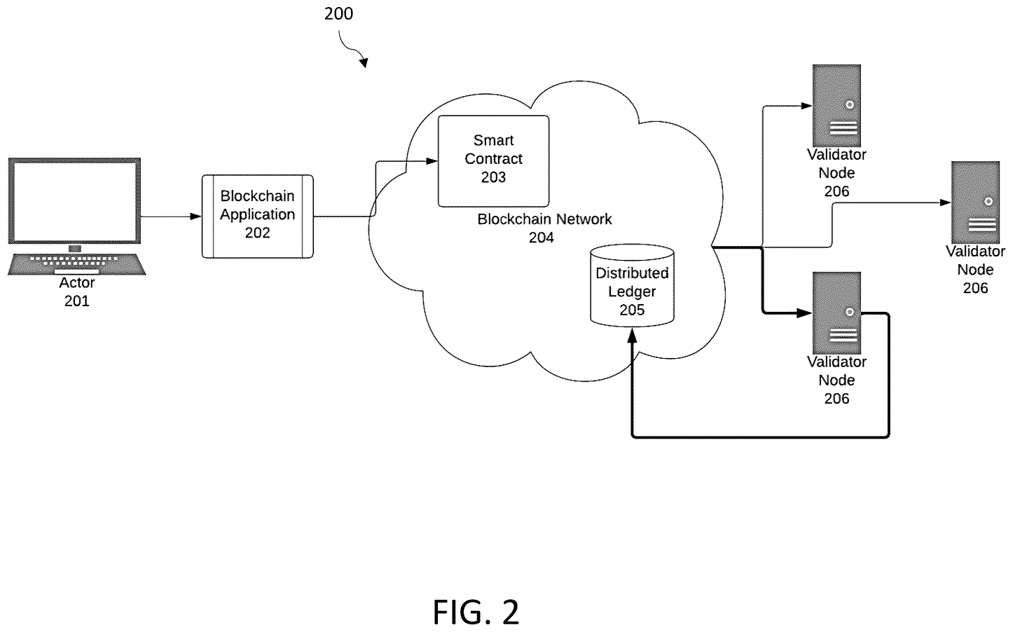

FIG. 2 is a representation, in block diagram form, of at least a portion of an example generic blockchain architecture or blockchain ecosystem 200, according to aspects of the present disclosure. While the description that follows may use terms from specific blockchains (e.g., Ethereum, Solana, etc.) it should be understood that the contact verification system of the present disclosure is not specific to any particular blockchain, as the general principles it relies on are shared by most if not all blockchains.

A blockchain ecosystem 200 contains one or more actors 201 that use a blockchain-aware application 202 to invoke smart contracts 203 on the blockchain network 204. These contract invocations are considered as transactions that, through the blockchain network 204, are distributed to one or more validator nodes 206. Using different strategies that are blockchain-dependent, and that are not material to the present disclosure, a validator node 206 will elect to approve the transaction, and permanently and immutably commit that transaction to the distributed ledger 205 stored in the blockchain network. The validation ensures the transaction meets the specific rules set out by the smart contract 203 associated with the transaction. This validation of rules set out by the smart contract, and the general visibility of all transactions and contracts on the blockchain ledger to all participants (actors and validators) on the blockchain network, provide the unique features of blockchains as opposed to traditional logs or transaction ledgers. The present contact verification system makes explicit use of this fact to provide non-repudiation, as described below.

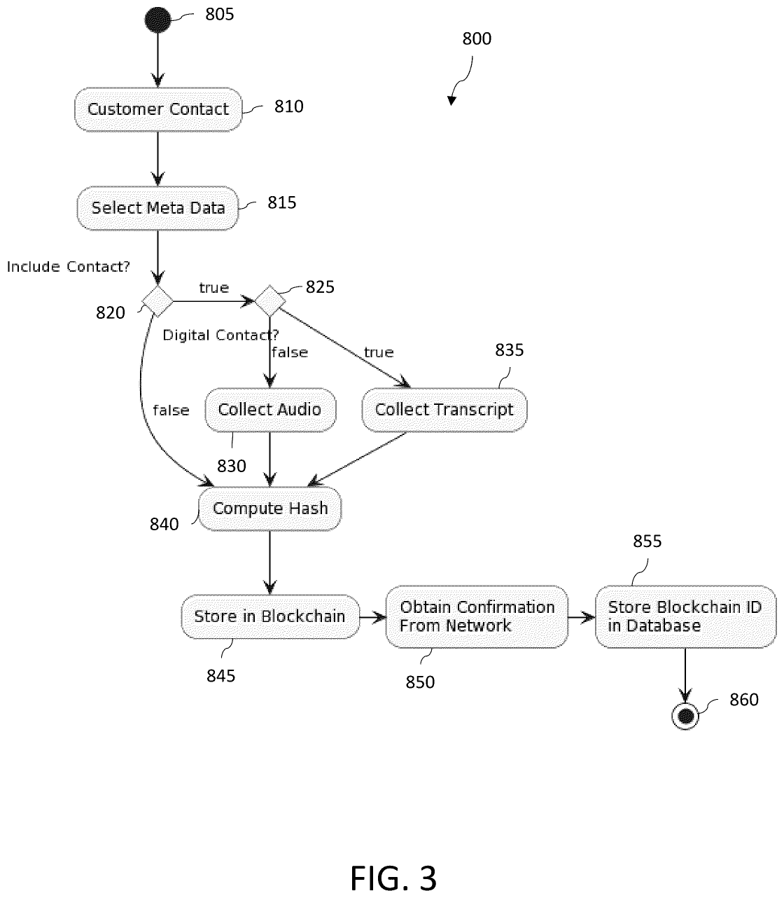

FIG. 3 is a representation, in flow diagram form, of at least a portion of an example contact hashing and storage method 800, according to aspects of the present disclosure. This flow may for example be invoked when a contact between a client and a contact center is completed, and is a candidate for having some or all of its data stored on the blockchain.

In step 805, the method begins.

In step 810, the method includes receiving data related to the customer contact 810 (e.g., recordings, transcripts, metadata, etc.).

In step 815, the method includes scanning the metadata for indications that the contact itself (e.g., a recording or transcript) is to be stored on the blockchain (e.g., because the client has verbally approved it for storage).

In step 820, the method includes determining whether to store the contact. If yes, execution proceeds to step 825. If no, execution proceeds to step 840.

In step 825, the method includes determining whether the contact was digital (e.g., non-voice). If yes, execution proceeds to step 835. If no, execution proceeds to step 830.

In step 830, the method includes collecting the recording for hash computation. The recording may for example be an audio, video, or screen activity recording. Execution then proceeds to step 840.

In step 835, the method includes collecting the transcript for hash computation. The transcript may for example be a transcription of an audio, video, or screen activity recording. Execution then proceeds to step 840.

In step 840, the method includes using a one-way encryption algorithm to compute a hash. Depending on the implementation, client selections, or operator selections, the hashed data may include any combination of metadata, audio recordings, video recordings, screen activity recordings, or transcripts thereof. The hash may for example be a block of alphanumeric data of standard size (e.g., 1024 alphanumeric characters) output by the one-way encryption, and may be considered a “fingerprint” of the incoming metadata, recordings, and/or transcripts. For example, 1024 characters of the ASCII character set (containing 256 possible characters) provide more than 4×10\hat{ }770 possible combinations. It is thus implausible that any two sets of input data would yield the same hash result, and also implausible that any achievable computation could decrypt the hash into the original data. The terms “hash”, “fingerprint”, and “one-way encryption” may, in this context, be used interchangeably.

In step 845, the method includes storing the hash in the blockchain. This may be done for example with a “smart contract”, which can be thought of as an application program interface (API) to the blockchain. Storing information on the blockchain may, in some cases, involve a micropayment or “gas” charge payable in a cryptocurrency that is native to the specific blockchain (e.g., ETH for Ethereum or SOL for Solana).

In step 850, the method includes obtaining confirmation from the network (e.g., the blockchain network 204 of the blockchain architecture or ecosystem 200, as seen for example in FIG. 2) that the hash was correctly stored in the blockchain. This confirmation may, for example, include a blockchain ID code indicating where the hash can be found in the blockchain.

In step 855, the method includes storing the blockchain ID code in a database, such as a local database or network database, so that the hash can, in the future, be retrieved from the blockchain using the ID code.

In step 860, the method is completed.

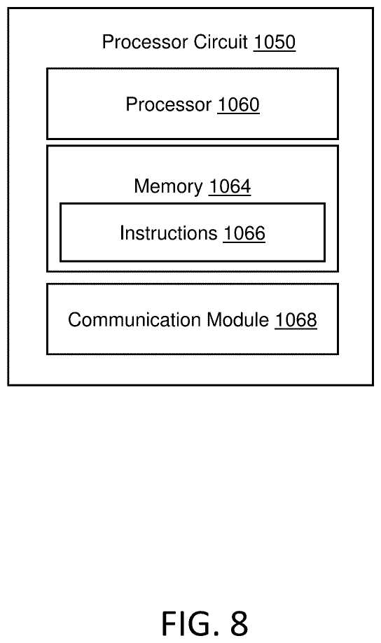

It is understood that the steps of the methods described herein may be performed in a different order than shown or described. Additional steps can be provided before, during, and after the steps as shown, and/or some of the steps shown or described can be replaced or eliminated in other embodiments. One or more of steps of the methods can be carried by one or more devices and/or systems described herein, such as components of the blockchain architecture 200 and/or processor circuit 1050 (see FIG. 8).

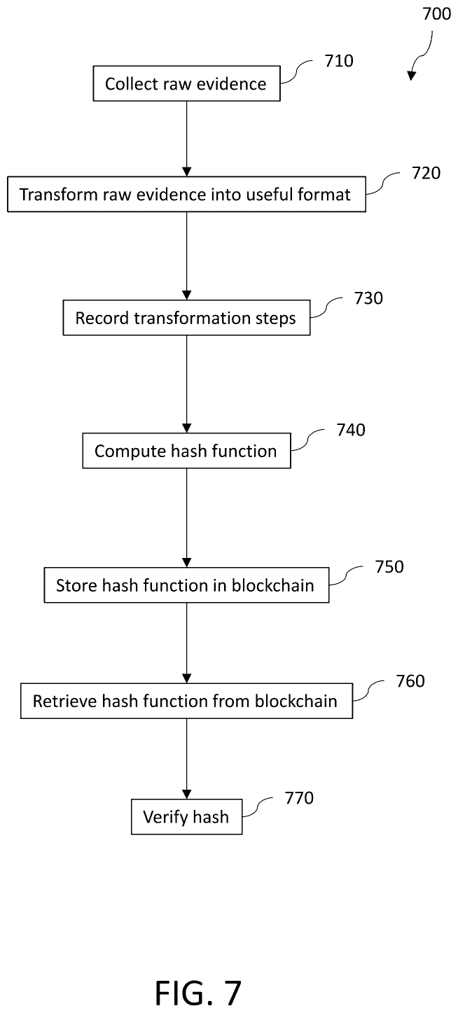

The flow diagrams provided herein are for exemplary purposes; a person of ordinary skill in the art will recognize myriad variations that nonetheless fall within the scope of the present disclosure. The logic of the methods may for example be shown as sequential. However, similar logic could be parallel, massively parallel, object oriented, real-time, event-driven, cellular automaton, or otherwise, while accomplishing the same or similar functions. In order to perform the method, a processor circuit (e.g., processor circuit 750 of FIG. 7) may divide each of the steps described herein into a plurality of machine instructions, and may execute these instructions at the rate of several hundred, several thousand, several million, or several billion per second, in a single processor or across a plurality of processors. Such rapid execution may be necessary in order to execute one or more of the methods in real time or near-real time as described herein. For example, in some embodiments, the system may need to perform computationally intensive encryption, either in real time or near-real time, in order to compute hash functions and efficiently store them on a blockchain.

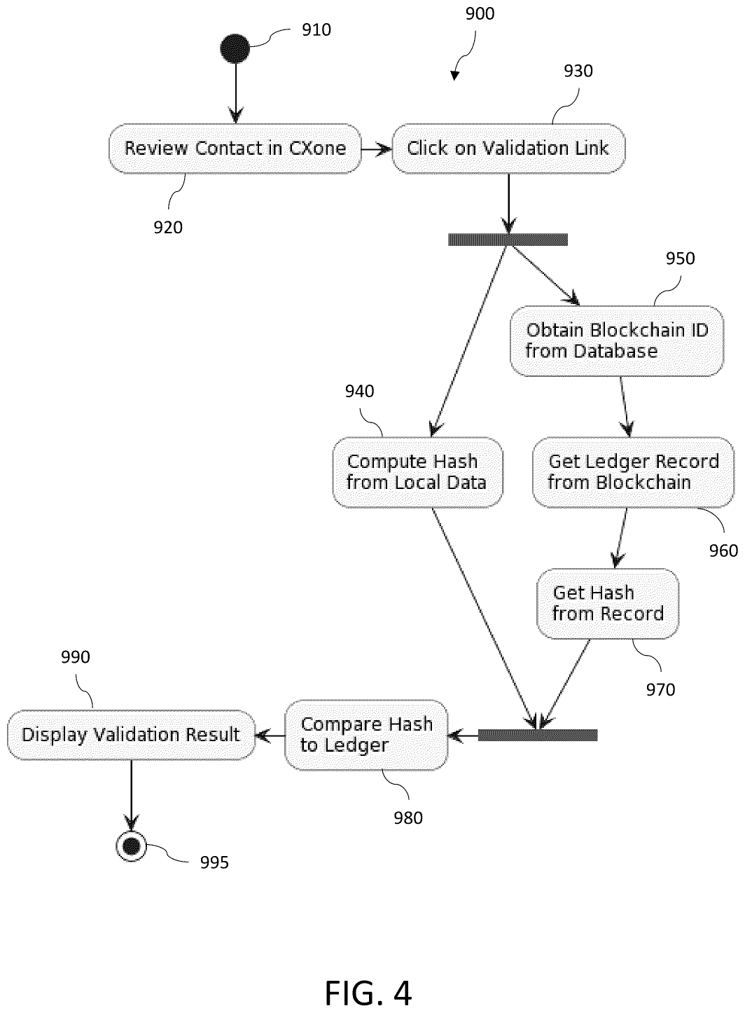

FIG. 4 is a representation, in flow diagram form, of at least a portion of an example contact verification method 900, according to aspects of the present disclosure. This flow may for example be invoked on the “validation” phase where an existing contact is inspected to validate that the locally-stored information is consistent with the blockchain ledger.

In step 910, the method begins.

In step 920, the method includes reviewing a contact stored in a local contact management system. The contact management system may for example include a link, button, or other user control to validate the contact.

In step 930, the method includes receiving a user instruction to validate the contact.

In step 940, the method includes computing a hash from the locally stored (or locally retrieved from a networked database) contact data. Execution then proceeds to step 980.

Steps 950, 960 and 970 may occur before, after, or in parallel with step 940.

In step 950, the method includes obtaining the blockchain ID associated with the contact (e.g., from a local database or locally accessed network database).

In step 960, the method includes retrieving, from the blockchain, the ledger record associated with the ID.

In step 970, the method includes obtaining the hash from the retrieved blockchain record. Execution then proceeds to step 980.

In step 980, the method includes comparing the hash retrieved from local storage to the hash retrieved from the blockchain.

In step 990, the method includes displaying the comparison, or an output based on the comparison. In one example, the two hashes may be displayed on the same screen at the same time. In another example, one hash may be overlaid on the other, such that any differences between the two are readily observable. In still another example, if the two hashes match, an output may be displayed such as “Hash match: Contact record is VALID”, and if the two hashes do not match, an output may be displayed such as “Hash mismatch: Contact record is INVALID.”

In step 995, the method is complete.

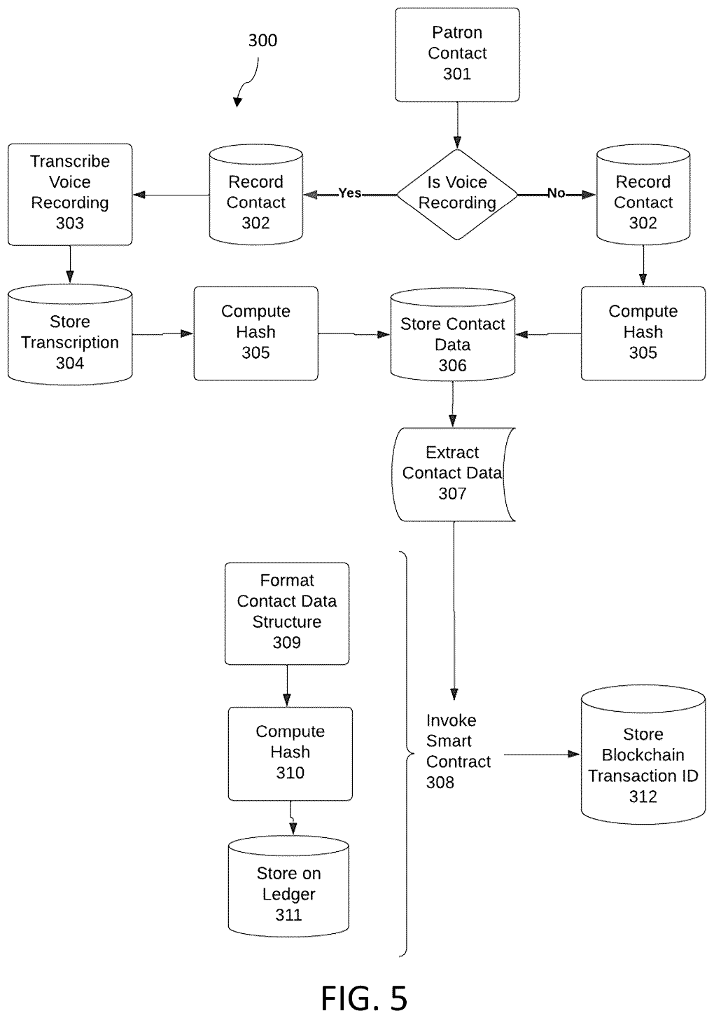

FIG. 5 is a representation, in block diagram form, of at least a portion of an example contact hashing and storage method 300, according to aspects of the present disclosure. In the case where a contact center 10 wishes to prevent a specific contact from being repudiated, the workflow presented in FIG. 3 may be followed. At the time that a patron contact 301 is completed, the contact center 10 stores a recording of the contact 302. Optionally, if the contact is a voice-based channel, the contact center may elect to create a text transcription 303 of the voice recording, and store either the recording or the transcription in a database 304. Note that that process described above may be similar or identical regardless of whether the patron contact was inbound or outbound. In either event (voice contact or digital), the contact center also stores a one-time, cryptographically secure hash 305 of the recording and (optionally) the recording transcript, and then stores the details of the contact in a software-specific database 306. These details may include, but are not limited to, the date and time the contact was made; a unique contact identifier; identifiers of the parties involved in the contact (one or more of customer phone number, contact center agent identifier, customer email address, social media identifier; or other demographic customer information); contact duration; recording hash; transcription hash; metadata hash. After the contact data has been stored, the contact center then extracts the stored data 307, and invokes a blockchain smart contract 308 that is specifically written to store all the contact data previously stored in the database as a transaction on the blockchain ledger. The smart contract 308 uses the contact data presented as inputs, concatenates them into an arbitrary but repeatable format 309, and then creates a one-time, cryptographically secure, hash 310 of that concatenation. The contact data and hash are then stored as the data for that transaction on the ledger 311. This transaction is uniquely identified by the contact identifier. When the transaction created by the smart contract is validated by a blockchain validator 204 (see FIG. 2) and stored on the ledger, a confirmation is returned that includes a unique transaction identifier 312 on the blockchain. This transaction identifier 312 is then stored with the contact data in the contact center database with the contact.

In order to protect confidential information about the contact participants, the smart contract can optionally store only the hash of the contact data 311. This loses the ability to “inspect” a transaction on the blockchain for its details, but retains the guarantee that the hash of the data identifying the contact details is stored on the ledger.

In another embodiment, the contact center software may also choose to not automatically store all contacts on the blockchain, as previously described, but instead offer a user interface control which allows an operator of the contact center to selectively pick contacts or aspects of contact interactions (e.g., the financial payment verification portion of a discussion) to be stored on the ledger. It should be evident that this present contact verification system is equally applicable to such a use case, and that selective storing of contacts can reduce the cost of blockchain actions, in the case where a specific blockchain charges fees to process smart contracts.

Without any loss of function to this disclosure, the data 311 may be stored on a private or a public blockchain. As noted below, the specifics of how to invoke smart contracts vary from blockchain to blockchain, and the distinction between private and public blockchains involves merely the visibility of blockchain ledger data to participants in the blockchain.

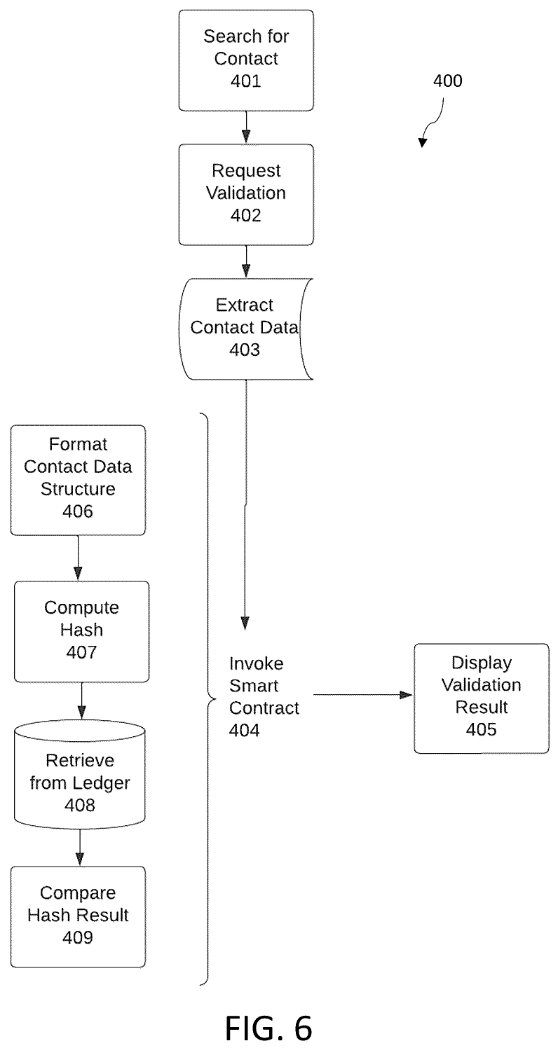

FIG. 6 is a representation, in block diagram form, of at least a portion of an example contact verification method 400, according to aspects of the present disclosure. An important aspect of non-repudiation is the validation that a contact occurred when it is purported to have occurred. In one embodiment, using the contact center software interface, an operator of the contact center can search for a list of contacts 401 that have been stored on the blockchain, using attributes such the date/time a contact has occurred and the presence of the unique blockchain transaction identifier stored at the time the transaction was stored. Through a user interface control, the operator invokes a validation 402 of the contact that: retrieves the contact data 403 previously used to store the contact on the blockchain ledger from the database; invokes a smart contract 404 that formats the contact data into a standard form 406 and computes a hash of the contact data 407 using the same rules as the contract used to store the contact on the ledger; retrieves the stored one-time hash for the contact from the blockchain ledger 408; compares the stored one-time hash to the newly computed hash 409; and confirms the values are identical which, as is commonly understood, is sufficient to confirm that the contact data used to generate the hash values are also identical. If the hash values are different, then this indicates that the contact data has been modified. The result of this validation 405 is then presented to the operator. Note that the above describes one embodiment of triggering the validation and presenting the results, and other embodiments may exist that are equally applicable to the essence of this disclosure.

The contact data may optionally include a transcript or voice recording. If such data has been used to compute the hash stored on the blockchain, the transcript or recording can again be retrieved from the contact database, hashed, and provided as an input to the validation smart contract. It is noted that the validation smart contract 404 may be part of the smart contract 308 of FIG. 3, or may be a separate smart contract operable on the same blockchain architecture.

It is important to note that any participant of a blockchain has access to the blockchain data. A key aspect of providing non-repudiation via the blockchain is the trust that validation of the data can be performed outside of the contact center software. Therefore, any external process similar to that described above may be used, whereby: the contact details are requested from the contact center operators through external means (e.g., a subpoena or other court order); the smart contract to create the validation hash is called by an external process; the stored one-time hash for the contact is retrieved from the blockchain ledger; the validation hash is compared to the retrieved hash to confirm they are identical, or prove that the contact data has been modified.

In a non-limiting example, a smart contract for the contact verification system to both enter a contact into the blockchain and retrieve the contact from the blockchain may be coded as follows:

```
// SPDX-License-Identifier: GPL-3.0
pragma solidity >=0.7.0 <0.9.0;
import “@openzeppelin/contracts/access/Ownable.sol”;
import “@openzeppelin/contracts/utils/Strings.sol”;
/**
* @title Nonrepudiate
* @dev Sample contract for non-repudiation of contacts
*/
contract Nonrepudiate is Ownable {
  mapping(uint256 => bytes32) private _ledger;
  constructor( )
  {
  }
  function registerContact(
```

| | |
|---|---|
| uint256 contact_id, | // unique identifier for contact |
| string calldata originatorId, | // identity of contact originator |
| string calldata destinationId, | // identity of contact destination |
| uint256 contactStart, | // epoch timestamp of contact start |
| uint256 contactEnd, | // epoch timestamp of contact end |
| uint256 contactHash | // optional hash of contact recording/transcript |

```
  ) public returns(bytes32)
  {
    require(_ledger[contact_id] == 0, “Nonrepudiate: cannot overwrite contact in ledger”);
    string memory contactData = _formatContact(contact_id, originatorId, destinationId,
contactStart, contactEnd, contactHash);
    bytes32 nonrepudiationHash = keccak256(abi.encode(contactData));
    _ledger[contact_id] = nonrepudiationHash;
    return nonrepudiationHash;
  }
  function validateContact(
```

| | |
|---|---|
| uint256 contact_id, | // unique identifier for contact |
| string calldata originatorId, | // identity of contact originator |
| string calldata destinationId, | // identity of contact destination |
| uint256 contactStart, | // epoch timestamp of contact start |
| uint256 contactEnd, | // epoch timestamp of contact end |
| uint256 contactHash | // optional hash of contact recording/transcript |

```
  ) public view returns(bool)
  {
    string memory contactData = _formatContact(contact_id, originatorId, destinationId,
contactStart, contactEnd, contactHash);
    bytes32 nonrepudiationHash = keccak256(abi.encode(contactData));
    return _ledger[contact_id] == nonrepudiationHash;
  }
  function _formatContact(
```

| | |
|---|---|
| uint256 contact_id, | // unique identifier for contact |
| string calldata originatorId, | // identity of contact originator |
| string calldata destinationId, | // identity of contact destination |
| uint256 contactStart, | // epoch timestamp of contact start |
| uint256 contactEnd, | // epoch timestamp of contact end |
| uint256 contactHash | // optional hash of contact recording/transcript |

```
  ) internal pure returns(string memory)
  {
    return string.concat(
      Strings.toString(contact_id), “:”,
      originatorId, “:”,
      destinationId, “:”,
      Strings.toString(contactStart), “:”,
      Strings.toString(contactEnd), “:”,
      Strings.toString(contactHash)
    );
  }
}
```

It will be appreciated by a person of ordinary skill in the art that different code could be used to achieve the same or similar effects, without departing from the spirit of the present disclosure.

The preceding description has been specifically related to non-repudiation of contacts between patrons and organizations. However, using the blockchain as an audit trail, via the same or similar tools, may also be applied evidence handling in criminal proceedings. While it is known in the art that the blockchain can be used in “evidentiary chain of custody”, an important aspect not addressed previously is in the transformation of evidence prior to entering the chain of custody.

FIG. 7 is a representation, in flow diagram form, of at least a portion of an example chain of evidence validation method 700, according to aspects of the present disclosure. This method may be used, for example, to verify that digital evidence in a criminal or civil court proceeding has not been tampered with, and that any steps used to transform the evidence are verifiable and repeatable.

Consider the case where security camera footage is collected from a crime scene. There are a multitude of types of security cameras, and each will generally store their data in a format that is particular to the camera. As part of entering such data into evidence, the camera footage is transformed into a standard video format (for example, but not limited to, MP4) in order that it may be easily viewed during a criminal investigation, shared with attorneys as part of discovery requests, or used in subsequent judicial proceedings. As the transformation can potentially introduce material modifications to the evidence, the process by which the raw camera data was transformed to a standard format must be explicitly recorded, including (but not limited to): a one-time hash of the original media file; the name of the transformation program used to modify the original media file; the version of the transformation program; a one-time hash of the transformation program binary; the parameters passed to the transformation program; a one-time hash of the transformed media file. When multiple steps are used to transform the original media file, each step would include the aforementioned data. One exemplary embodiment is found in the method 700 that is further described below.

In step 710, the method includes collecting a piece of raw digital evidence. The evidence may for example be or include a document, photograph, video recording, audio recording, sensor measurement, etc.

In step 720, the method includes transforming the raw evidence into a format that is human-readable or otherwise useful to investigators, courts, juries, regulatory agencies, etc. Such transformation may for example include converting a digital file from one format to another (e.g., converting a video file from a native security system format to a standardized format such as MP4), but may also include more detailed actions such as image enhancement, audio enhancement, cropping, zooming, resizing, compression/decompression, noise filtering, font substitution, language translation, subtitling, and otherwise, or combinations thereof.

In step 730, the method includes recording the steps that were used in the transformations of step 720. This recording may for example be a simple text file that lists the transformation steps in order of occurrence, and may include details such as the input file name, operating system and version number, specific tools used in the transformation, specific settings and actions within the tools, and output file name.

In step 740, the method includes computing a hash of the input file, the output file, and the transformation steps.

In step 750, the method includes storing the hash result in the blockchain using the methods described above.

In step 760, the method includes, at a later time, retrieving the hash result from the blockchain using the methods described above, in order to validate the digital evidence.

In step 770, the method includes verifying the hash. This may be done for example by recomputing the hash based on stored versions of the input file, the output file, and the transformation steps, and then comparing the recomputed hash to the hash retrieved from the blockchain. If the two hashes match, then it is mathematically implausible that any of the input file, the output file, or the transformation steps have been tampered with or otherwise altered. In some embodiments, step 770 also includes repeating the transformation steps to produce a new output file, and using the new output file rather than the original output file to recompute the hash. In this case, if the hashes match, this indicates that the new output file is identical to the original output file, thus further validating the transformation steps and the chain of custody for the digital evidence.

In some embodiments, a software program to manage evidentiary chain of custody can be enhanced to: collect the transformation data; collect a unique identifier of the evidence item from the software program; format the data into a simple and human-readable data structure (such as, but not limited to, JSON); invoke a smart contract on the blockchain, passing as parameters the transformation data structure and evidence unique identifier; store the human-readable transformation data structure on the blockchain through the smart contract; capture the transaction identifier from the blockchain upon successful validation of the smart contract invocation; storing the transaction identifier in the chain of custody software program.

Note that the present evidence verification system does not rely on having a software program to manage an evidentiary chain of custody, and there are a multiplicity of ways to invoke a smart contract on a blockchain, including (but not limited to) a web page that collects the data in a form and invokes the smart contract through commonly-used JavaScript code. The key aspects of this disclosure are that the transformation steps are immutably recorded on the blockchain, and that those steps are visible to anyone that has access to the blockchain. Through this transparency, anyone can therefore reliably reproduce the steps involved in transforming the evidence from one form to another and prove it has not been materially tampered with.

FIG. 8 is a schematic diagram of a processor circuit 1050, according to aspects of the present disclosure. The processor circuit 1050 may be implemented in the contact verification system 200, or other devices or workstations (e.g., third-party workstations, network routers, etc.), or on a cloud processor or other remote processing unit, as necessary to implement the modules and methods disclosed herein. As shown, the processor circuit 1050 may include a processor 1060, a memory 1064, and a communication module 1068. These elements may be in direct or indirect communication with each other, for example via one or more buses.

The processor 1060 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1060 may also include another hardware device, a firmware device, or any combination thereof configured to perform the operations described herein. The processor 1060 may also be implemented as a combination of computing devices, e.g., a combination of a DSP and a microprocessor, a plurality of microprocessors, one or more microprocessors in conjunction with a DSP core, or any other such configuration.

The memory 1064 may include a cache memory (e.g., a cache memory of the processor 1060), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1064 includes a non-transitory computer-readable medium. The memory 1064 may store instructions 1066. The instructions 1066 may include instructions that, when executed by the processor 1060, cause the processor 1060 to perform the operations described herein. Instructions 1066 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1068 can include any electronic circuitry and/or logic circuitry to facilitate direct or indirect communication of data between the processor circuit 1050, and other processors or devices. In that regard, the communication module 1068 can be an input/output (I/O) device. In some instances, the communication module 1068 facilitates direct or indirect communication between various elements of the processor circuit 1050 and/or the contact verification system 200. The communication module 1068 may communicate within the processor circuit 1050 through numerous methods or protocols. Serial communication protocols may include but are not limited to United States Serial Protocol Interface (USSPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, or data sharing between the processor and a central server) may be accomplished using any suitable wireless or wired communication technology, such as a cable interface such as a universal serial bus (USB), micro USB, Lightning, or FireWire interface, Bluetooth, Wi-Fi, ZigBee, Li-Fi, or cellular data connections such as 2G/GSM (global system for mobiles), 3G/UMTS (universal mobile telecommunications system), 4G/LTE/WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the contact verification system advantageously provides improved non-repudiation ability to contact centers and evidence handlers. Accordingly, it can be seen that the contact verification system fills a long-standing need in the art, by addressing the limitations of present systems and improving the operation of associated contact center computer systems and evidence handling computer systems. A number of variations are possible on the examples and embodiments described above. For example, different types of contact center data and/or digital evidence may be hashed and stored on the blockchain, without departing from the spirit of the present disclosure.

Accordingly, the logical operations making up the embodiments of the technology described herein are referred to variously as operations, steps, objects, layers, elements, components, or modules. Furthermore, it should be understood that these may occur or be performed or arranged in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the dimensional reduction of the disclosed system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the contact verification system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system adapted to automatically validate stored information related to a contact session, the system comprising:
a processor and a non-transitory computer readable medium operably coupled thereto, the computer readable medium comprising a plurality of instructions stored in association therewith that are accessible to, and executable by, the processor, to perform operations which comprise:
receiving a recording or transcript of a contact session;
receiving or generating metadata related to the recording or transcript;
storing the recording, transcript, and metadata in a memory;
with a hash function, computing a hash of at least the recording, transcript, or metadata;
storing the hash in a blockchain different from the memory, wherein the hash is indexed within the blockchain by at least a portion of the metadata;
using the at least a portion of the metadata, retrieving the hash from the blockchain;
retrieving the hash from the memory or, with the hash function, re-computing the hash of the recording, transcript, or metadata;
comparing the retrieved hash to the re-computed hash or the hash retrieved from the memory;
if the retrieved hash matches the re-computed hash or the hash retrieved from the memory, generating a first output; and
if the retrieved hash does not match the re-computed hash or the hash retrieved from the memory, generating a second output.

2. The system of claim 1, wherein the recording includes at least one of a voice recording of the contact session or a recording of computer screen activity of the contact session.

3. The system of claim 1, wherein the transcript includes a recording of at least one of a text interaction, a text translation of a voice interaction, or a text translation of computer screen activity.

4. The system of claim 1, wherein the hash function comprises a one-way hash function.

5. The system of claim 1, wherein the metadata includes at least one of a date, a time, a unique contact identifier, a phone number, a contact center agent identifier, an email address, a social media identifier, or a contact duration.

6. The system of claim 1, wherein the first output comprises an indication that the recording or transcript is validated, and the second output comprises an indication that the recording or transcript is not validated.

7. The system of claim 1, wherein the blockchain is a public blockchain, a smart contract includes at least some of the operations, and the operations further comprise:
paying a usage fee for the public blockchain; and
charging a customer for the usage fee.

8. The system of claim 1, wherein the blockchain is a private blockchain, a smart contract includes at least some of the operations, and the operations further comprise:
charging a customer a usage fee for the private blockchain.

9. A computer-implemented method adapted to automatically validate stored information related to a contact session, the method comprising:
receiving a recording or transcript of a contact session;
receiving or generating metadata related to the recording or transcript;
storing the recording, transcript, and metadata in a memory;
with a hash function, computing a hash of at least the recording or transcript, or metadata;
storing the hash in a blockchain different from the memory, wherein the hash is indexed within the blockchain by at least a portion of the metadata;
using the at least a portion of the metadata, retrieving the hash from the blockchain;
retrieving the hash from the memory or, with the hash function, re-computing the hash of the recording or transcript;
comparing the retrieved hash to the re-computed hash or the hash retrieved from the memory;
if the retrieved hash matches the re-computed hash or the hash retrieved from the memory, generating a first output; and
if the retrieved hash does not match the re-computed hash or the hash retrieved from the memory, generating a second output.

10. The method of claim 9, wherein the recording includes at least one of a voice recording of the contact session or a recording of screen activity of the contact session.

11. The method of claim 9, wherein the transcript includes a recording of at least one of a text interaction, a text translation of a voice interaction, or a text translation of computer screen activity.

12. The method of claim 9, wherein the hash function comprises a one-way hash function.

13. The method of claim 9, wherein the metadata includes at least one of a date, a time, a unique contact identifier, a phone number, a contact center agent identifier, an email address, a social media identifier, or a contact duration.

14. The method of claim 9, wherein the first output comprises an indication that the recording or transcript is validated, and the second output comprises an indication that the recording or transcript is not validated.

15. The method of claim 9, wherein the blockchain is a public blockchain, a smart contract includes at least a portion of the method, and the method further comprises:
paying a usage fee for the public blockchain; and
charging a customer for the usage fee.

16. The method of claim 9, wherein the blockchain is a private blockchain, a smart contract includes at least a portion of the method, and the method further comprises:
charging a customer a usage fee for the private blockchain.

17. A computer-implemented method adapted to automatically validate a chain of custody related to a piece of electronic evidence, the method comprising:
receiving the piece of electronic evidence;
receiving or generating metadata related to the piece of electronic evidence;
performing steps to transform the piece of electronic evidence into a transformed piece of electronic evidence;
storing the piece of electronic evidence, the steps, the transformed piece of electronic evidence, and the metadata in a memory;
with a hash function, computing a hash of at least the piece of evidence, the steps, and the transformed piece of electronic evidence;
storing the hash in a blockchain different from the memory, wherein the hash is indexed within the blockchain by at least a portion of the metadata;
using the at least a portion of the metadata, retrieving the hash from the blockchain;
retrieving the hash from the memory or, with the hash function, re-computing the hash of at least the piece of evidence, the steps, and the transformed piece of electronic evidence;
comparing the retrieved hash to the re-computed hash or the hash retrieved from the memory;
if the retrieved hash matches the re-computed hash or the hash retrieved from the memory, generating a first output; and
if the retrieved hash does not match the re-computed hash or the hash retrieved from the memory, generating a second output.

18. A computer-implemented method adapted to automatically validate an electronic data structure, the method comprising:
receiving the electronic data structure;
receiving or generating data related to the electronic data structure;
storing the electronic data structure or the generated data in a memory;
with a hash function, computing a hash of at least the electronic data structure or the data;
storing the hash in a blockchain different from the memory, wherein the hash is indexed within the blockchain by at least a portion of the data;
using the at least a portion of the data, retrieving the hash from the blockchain;
retrieving the hash from the memory or, with the hash function, re-computing the hash of at least the electronic data structure or the data;
comparing the retrieved hash to the re-computed hash or the hash retrieved from the memory;
if the retrieved hash matches the re-computed hash or the hash retrieved from the memory, generating a first output; and
if the retrieved hash does not match the re-computed hash or the hash retrieved from the memory, generating a second output.

19. The computer-implemented method of claim 18, wherein the electronic data structure comprises a recording or transcript of a customer interaction or a piece of electronic evidence.

20. The computer-implemented method of claim 18, wherein the data comprises metadata or processing steps.
